(19) United States
(12) Patent Application Publication
(10) Pub. No.: US 2006/0250674 A1
(43) Pub. Date: Nov. 9, 2006

(54) Optical scanning apparatus

(75) Inventor: Osamu Akiyama, Sagamihara-shi (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Business Technologies, Inc.

(21) Appl. No.: 11/486,236

(22) Filed: Jul. 12, 2006

Related U.S. Application Data
(63) Continuation of application No. 11/020,849, filed on Dec. 23, 2004.

(30) Foreign Application Priority Data
Jun. 4, 2004 (JP) JP2004-166928

(51) Int. Cl. G02B 26/08

(52) U.S. Cl. 359/206; 359/808

(57) ABSTRACT

An optical scanning apparatus includes: an optical deflector having a rotatable polygon mirror for reflecting a light beam projected thereon; an fθ lens for transmitting the light beam reflected on a light reflecting surface of the polygon mirror; a cylindrical lens for transmitting the light beam passing through the fθ lens; and a sound-insulating case for the fθ lens having an opening or for the cylindrical lens having an opening, wherein the sound-insulating case houses the optical deflector and the opening of the sound-insulating case is sealed hermetically with the fθ lens or the cylindrical lens.

### RELATED APPLICATIONS

This application is a Continuation of U.S. patent application Ser. No. 11/020,849 filed Dec. 23, 2004, which claims priority from Japanese Application No. 2004-166928 filed Jun. 4, 2004. The disclosure of U.S. patent application Ser. No. 11/020,849 is hereby incorporated by reference.

### BACKGROUND OF THE INVENTION

The present invention relates to an optical scanning apparatus for use in an image forming apparatus such as a laser beam printer, a laser copying machine, and a laser facsimile machine.

In an image forming apparatus such as a laser beam printer, image writing means is arranged in such a way that a laser beam is applied to the polygon mirror rotating at a uniform speed according to the information having been read, and the reflected beam is projected on a photoconductor surface through scanning operation, whereby an image is recorded.

The polygon mirror at a low speed is operated in a state directly fixed to the rotary shaft of a drive motor. When the speed is increased, the polygon mirror is fixed to the outer tube member, and is rotated using an air dynamic pressure bearing rotating in a separate form without contacting the inner tube member fixed and arranged Further, the air dynamic pressure bearing provides such advantages as a long service life and low noise since it rotates in a non-contact state.

The air dynamic pressure bearing is composed of a lower thrust plate, a fixed bearing member, an upper thrust plate, and a rotating bearing member rotatably fixing the polygon mirror. The polygon mirror is driven by a drive motor constituted by a magnetic coil fixed on a base, and a magnet, forming a rotor, integrally built with the polygon mirror.

The rotor unit having a rotating bearing member rotating opposite to the fixed bearing member fixed on the support base member is mutual radial hydrodynamic rotation in the radial dynamic pressure section. Further, a thrust plate forming a vertical surface with respect to the fixed bearing member is fixed on both shaft ends of the fixed bearing member. A rotating bearing member that rotates in the state sandwiched between the upper thrust plate and lower thrust plate positioned in the vertical direction performs a thrust dynastic pressure rotation in the upper and lower thrust dynamic pressure bearing sections.

When the rotor is driven by the drive motor constituted by a magnet coil and a magnet, the rotor continues a smooth high-speed rotation in a non-contact state without contacting the dynamic pressure bearing.

The polygon mirror is rotated as rotor is rotating and a laser beam emitted from a semiconductor laser deflects and scans toward a photoconductor.

Patent Documents 1, 2, 3 and 4 disclose the commonly known art of stabilizing the rotation by regulating the air flow around the polygon mirror, and reducing the ambient noise due to rotation of the polygon mirror as well as the noise produced by the equipment.

In the optical deflector described in the Patent Document 1, the rotation space of the polygon mirror is processed into a cylindrical form having a center aligned with the rotating center of the polygon mirror.

The optical deflector described in the Patent Document 2 has a plurality of segment inner walls provided inside the protective case covering the polygon mirror. A plurality of air flow paths are formed between the polygon mirror and segment inner wall, and pressure change is damped by mutual interference among air flows resulting from the change in the pressure of air flowing in these air flow paths.

In the optical deflector described in the Patent Document 3, the inner peripheral surface of the case opposed to the light reflecting surface of the polygon mirror is processed in the cylindrical form coaxial with the rotary center axis of the rotary unit, and an opening is provided at specified position of the inner peripheral surface of the case. The length of the opening in the direction of the rotary center axis of the rotating unit is set to +1 mm or less with respect to the plate thickness of the polygon mirror.

In the optical deflector described in the Patent Document 4, a protrusion is arranged on the inner peripheral wall in the vicinity of the opening of the case, thereby ensuring that the polygon mirror is not subjected to variation in pressure in the same phase.

Above-mentioned Patent Documents 1, 2, 3 and 4 denote Official Gazette of Japanese Patent Publications Tokkaihei 8-5947, Tokkai 2001-249298, Tokkaihei 7-306373 (equivalent to U.S. Pat. No. 5,726,699), and Tokkaihei 10-221630, respectively.

In the prior art optical deflector, if the rotary unit including the polygon mirror is turned at a high speed by an air dynamic pressure bearing, unstable rotation is caused by a high degree of windage loss as a load, accompanied by the problem of the jittering characteristic being adversely affected.

To solve the problem of uneven speed of the polygon mirror in the uniform speed drive mode, the mass of the rotary unit including the polygon mirror is increased to raise the inertia force. However, this will reduce the optical deflector starting characteristic.

Further, unstable rotation of the polygon mirror is caused by the change in air resistance during one rotation of the polygon mirror, due to uneven distance between the protective case for storing the polygon mirror and the locus of the rotation on the outer peripheral surface of the polygon mirror, with the result that the jittering characteristic is adversely affected.

In the optical deflector described in the Patent Document 1, a big fluctuation in pressure occurs in the vicinity of the soundproofing glass, so it is apparent that there is no noise preventive effect.

In the optical deflector described in the Patent Document 2, a pressure variation is rather increased, noise of high bandwidth is produced, and space is expanded. Thus, it is apparent that torque is increased.

The optical deflector described in the Patent Document 3 reduces the torque in that the required space is minimized, but cannot reduce a turbulent flow.

The optical deflector described in the Patent Document 4 uses the technique used in pumps as well as fans. It reduces the frequency dominant noise of “the number of polygon mirror faces times speed of rotation”.

The aforementioned Patent Documents describe the techniques of reducing the torque of the rotary unit at the time of high speed rotation and minimizing the ambient noise. The present invention takes a different approach, and achieves a remarkable sound insulating effect.

### SUMMARY OF THE INVENTION

The present invention is to solve the aforementioned problems with the optical deflector. The sound insulating case is configured in such a way that a lens (an fθ lens or a cylindrical lens) located, inside the optical scanning apparatus, subsequent to the optical deflector, forms part of the sound insulating case. This configuration allows the optical deflector to be completely covered, and thus provides an optical scanning apparatus of excellent sound insulation characteristics capable of ensuring that the noise produced from the polygon mirror rotating at a high speed does not leak out of the equipment.

The aforementioned object can be achieved by any one of the following structures (1) through (3).

Structure (1): An optical scanning apparatus comprising: an optical deflector having a rotatable polygon mirror for reflecting a light beam projected thereon; an fθ lens for transmitting the light beam reflected on a light reflecting surface of the polygon mirror; a cylindrical lens for transmitting the light beam passing through the fθ lens; and a sound-insulating case for the fθ lens having an opening through which the light beam passing through the fθ lens passes, wherein the sound-insulating case houses the optical deflector and the opening of the sound-insulating case is sealed hermetically with the fθ lens.

Structure (2): An optical scanning apparatus comprising: an optical deflector having a rotatable polygon mirror for reflecting a light beam projected thereon; an fθ lens for transmitting the light beam reflected on a light reflecting surface of the polygon mirror; a cylindrical lens for transmitting the light beam passing through the fθ lens; a first sound-insulating case for the fθ lens having a first opening through which the light beam transmitted through the fθ lens passes; and a second sound-insulating case for the cylindrical lens having a second opening through which the light beam transmitted through the cylindrical lens passes, the second sound-insulating case housing the first sound-insulating case, wherein the first sound-insulating case houses he optical deflector, and wherein the first opening of the first sound-insulating case is sealed hermetically with the fθ lens, and the second opening of the second sound-insulating case is sealed hermetically with the cylindrical lens.

Structure (3): An optical scanning apparatus comprising: an optical deflector having a rotatable polygon mirror for reflecting a light beam projected thereon; an fθ lens for transmitting the light beam reflected on a light reflecting surface of the polygon mirror; a cylindrical lens for transmitting the light beam passing through the fθ lens; a sound-insulating case for the cylindrical lens having an opening through which the light beam transmitted through the cylindrical lens passes, wherein the sound-insulating case houses the optical deflector and the opening of the sound-insulating case is sealed hermetically with the cylindrical lens.

### BRIEF DESCRIPTION OF THE DRAWINGS

FIG. 1 is a perspective view representing an embodiment of an optical scanning apparatus with the protective case removed;

FIG. 2(a) is a plan view showing an optical deflector with the protective case removed, and FIG. 2(b) a cross sectional view showing the same;

FIG. 3(a) is a plan cross sectional view of the first embodiment of a sound-insulating means of the optical scanning apparatus, and FIG. 3(b) a front cross sectional view of the same;

FIG. 4(a) is a plan cross sectional view of the second embodiment of a sound-insulating means of the optical scanning apparatus, and FIG. 4(b) is a front cross sectional view of the same;

FIG. 5 is a front cross sectional view of the third embodiment of a sound-insulating means of the optical scanning apparatus;

FIGS. 6(a) and 6(b) are plan cross sectional view showing still another embodiment of the optical scanning apparatus; and

FIG. 7(a) is a plan cross sectional view showing still another embodiment of the optical scanning apparatus, and FIG. 7(b) a front cross sectional view showing the same.

### DETAILED DESCRIPTION OF THE PREFERRED EMBODIMENT

<Optical Scanning Apparatus>

The following describes the preferred embodiments of the optical scanning apparatus equipped with an optical deflector of the present invention, with reference to drawings.

In the image forming apparatus of a laser printer and others, an optical scanning apparatus as an image writing means is arranged in such a way that a laser beam is applied to the laser beam to the polygon mirror, rotating at a high speed, of the optical deflector according to the information having been read, and the reflected beam is projected on the photoconductor surface of an image carrier through scanning operation, whereby an image is recorded.

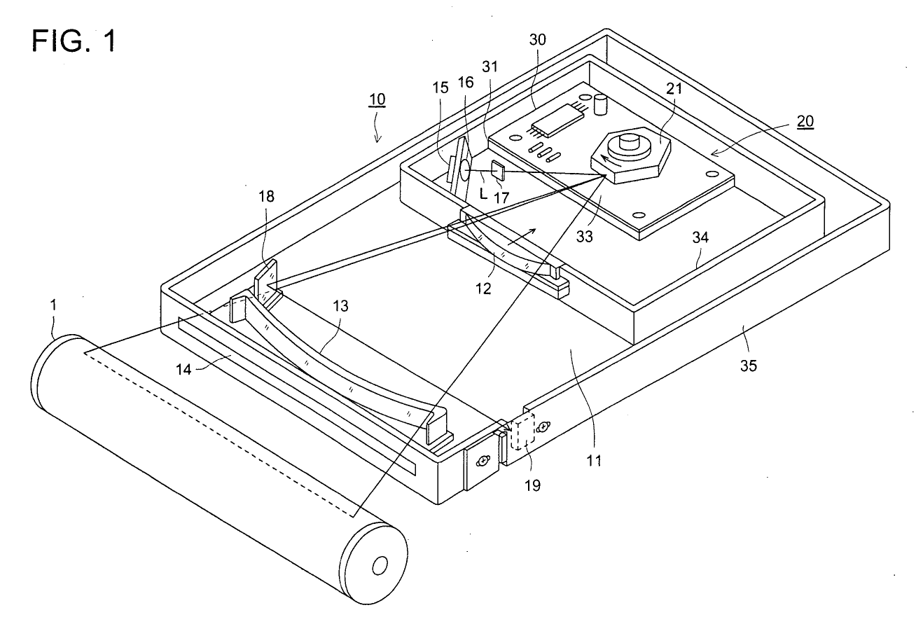

FIG. 1 is a perspective vies representing an embodiment of an optical scanning apparatus 10 with the case removed from the main unit of the optical scanning apparatus.

FIG. 1 shows the main unit of the optical scanning apparatus. Numeral 12 denotes an fθ lens, 13 a second cylindrical lens, 14 a cover glass, 15 a semiconductor laser, 16 a collimator lens, 17 a first cylindrical lens, 18 a timing detection index mirror, 19 a synchronism detecting index sensor, and 20 an optical deflector constituted by a polygon mirror 21 and others.

The optical deflector 20 and optical members 12 through 19 of the scanning optical system are arranged and fixed at the specified positions inside the main unit of the optical scanning apparatus 11.

The light beam L emitted from the semiconductor laser 15 is converted into a parallel beam by the collimator lens 16 and is incident to the polygon mirror 21 after passing through the spherical lens 17 of the first image formation optical system. The reflected light of the polygon mirror 21 passes through the second image formation optical system constituted by the fθ lens 12 and second cylindrical lens 13. After passing through the cover glass 14, it scans the peripheral surface of an image carrier 1 with a specified spot diameter in the state deviated by a predetermined pitch in the sub-scanning direction. The main scanning direction is already fine-adjusted by an adjusting mechanism (not illustrated). To detect synchronism for each line, the luminous flux prior to scanning is incident to the index sensor 19 through the index mirror 18.

In the optical deflector 20 where the polygon mirror 21 rotating at a high speed as a rotary unit, an air dynamic pressure bearing is arranged between the rotary unit and a stator unit, and the rotary unit is turned at a high speed.

Numeral 34 denotes a sound-insulating case for the fθ lens and accommodates the polygon mirror 21, with the opening thereof sealed by the fθ lens 12. Further, the numeral 35 indicates a sound-insulating case for the main unit. It accommodates the polygon mirror 21, the fθ lens 12, the cylindrical lens 13 and others. The opening thereof is sealed with a cover glass 14 as an example of the transparent vibration proof member Upper potions of the sound-insulating case 34 and 35 are not shown in FIG. 1.

This sound-insulating case, for example, is sealed by covering it with a main unit case not shown in FIG. 1. Further, any other configuration can be used only if sealing and sound insulation are ensured.

<Optical Deflector>

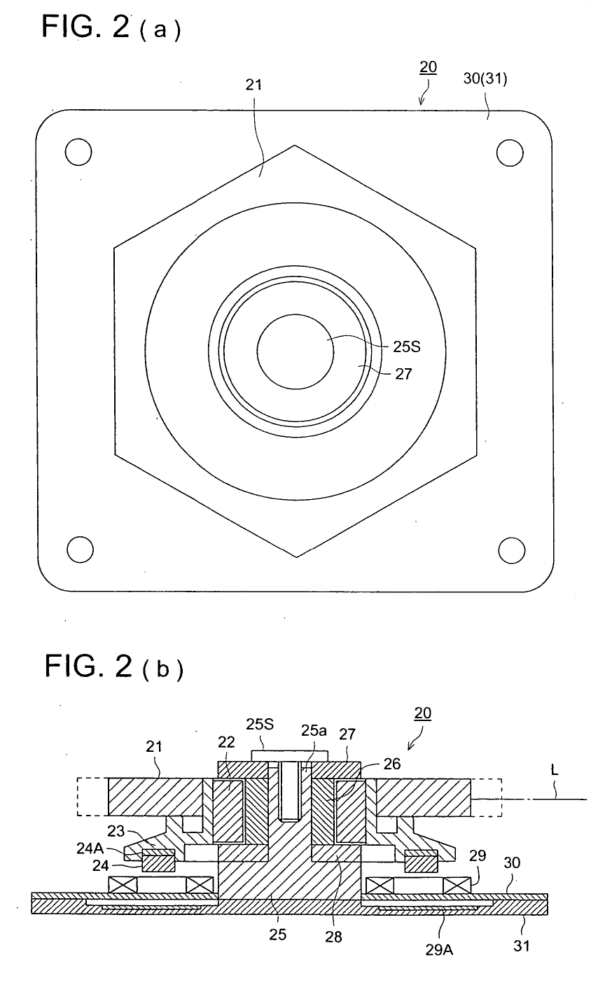

FIG. 2(a) is a plan view of the optical deflector 20 with the protective case removed. FIG. 2(b) is a cross sectional view of the optical deflector 20.

The optical deflector 20 is constituted by a rotary unit and a stator unit.

The rotary unit for providing a high speed rotation of the optical deflector 20 comprises: a polygon mirror 21; a cylindrical rotary bearing member 22 (hereinafter referred to as “external cylindrical member” about the rotary shaft); a polygon mirror holding member 23, fitted to the inner peripheral surface of the polygon mirror 21, for fixing the outer peripheral surface of the external cylindrical member 22; a rotation drive magnet 24; and a rotary yoke 24A.

The inner diameter of the external cylindrical member 22 is greater than the outer diameter of the stator unit securing bearing member (hereinafter referred to as “internal cylindrical member”) 26, by a very small amount of space adjusted in the order of several microns. The inner peripheral surface of the external cylindrical member 22 and the outer peripheral surface of the internal cylindrical member 26 constitute a radial dynamic pressure bearing. To ensure stable rotation, the external cylindrical member 22 is preferably made of alumina and ceramic such as silicon nitride.

The top end face of the external cylindrical member 22, facing the thrust surface of an upper thrust plate 27, constitutes an upper thrust dynamic pressure bearing. Similarly, the bottom end face of the external cylindrical member 22, facing the thrust surface of a lower thrust plate 28, constitutes a lower thrust dynamic pressure bearing.

A dynamic pressure generation groove is formed on the thrust surface of the opposed thrust dynamic pressure bearing The rotor unit performs a thrust rotation with respect to the main unit secured portion through the thrust dynamic pressure bearing.

The polygon mirror holding member 23 and polygon mirror 21 are made of the material having the same thermal expansion coefficient, for example, aluminum alloy.

An internal cylindrical member 26 processed in a cylindrical form is arranged and secured outside the cylindrical radial shaft 25a standing upright on the support base 25. The radial bearing and internal cylindrical member 26 constitute a radial fixing member. The internal cylindrical member 26 is made of alumina and ceramic such as silicon nitride.

The cylindrical upper thrust plate 27 and lower thrust plate 28 are arranged and secured on the top and bottom end faces of the internal cylindrical member 26 in the direction almost perpendicular to the radial shaft 25a, and constitute a thrust fixing member. The upper thrust plate 27 and lower thrust plate 28 are made of alumina and ceramic such as silicon nitride. The internal cylindrical member 26, upper thrust plate 27 and lower thrust plate 28 are mounted on the radial shaft 25a and are secured by a screw 25S.

A printed circuit board 30 is installed on the top face of the base member 31 wherein a plurality of magnetic coils 29 are arranged flush therewith. The numeral 29A denotes a stator yoke positioned face to face with the magnetic coil 29.

Support base 25, internal cylindrical member 26, upper thrust plate 27, lower thrust plate 28, magnet coil 29, stator yoke 29A, printed circuit board 30 and base member 31 are integrally built to form a stator unit.

The rotor unit mounted on the stator unit is ensured that the polygon mirror 21 and the polygon mirror holding member 23 accurately rotates with respect to the rotating center of the external cylindrical member 22, and the dynamic balance can be adjusted to a minimum.

<Sound Insulating means for an Optical Scanning Apparatus>

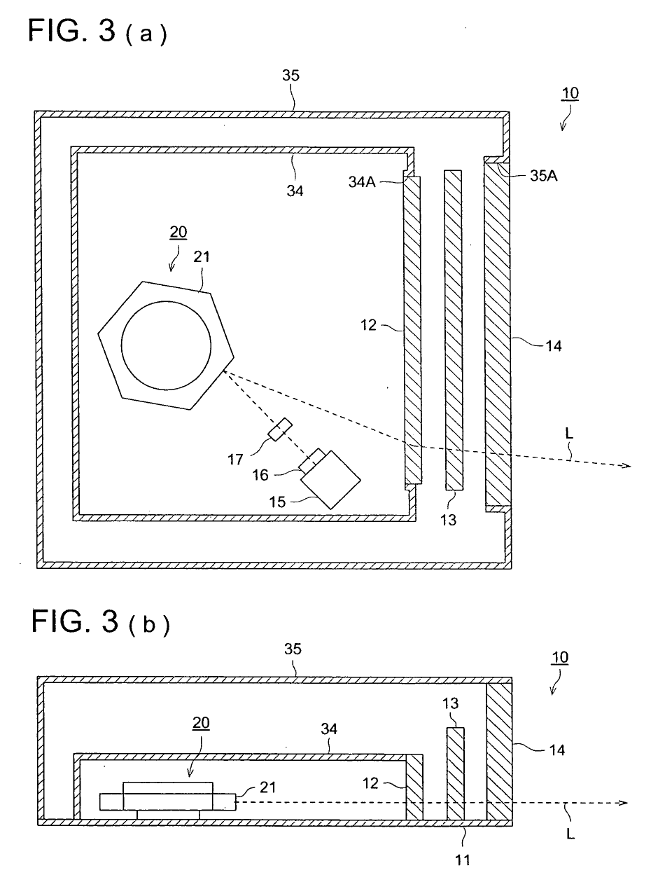

FIG. 3(a) is a plan cross sectional view of the first embodiment of a sound-insulating means of the optical scanning apparatus 10, and FIG. 3(b) a front cross sectional view of the same.

The optical deflector 20 and the incident optical system constituted by a semiconductor laser 15, a collimator lens 16 and a first cylindrical lens 17 are arranged inside the sound-insulating case 34 for the fθ lens sealed against noise. The fθ lens 12 is mounted on the opening 34A of the sound-insulating case 34 for the fθ lens, whereby the opening 34A is sealed. This configuration allows the optical deflector 20 and the incident optical system to be sealed and accommodated in the sound-insulating case 34 for the fθ lens, with the result that ambient noise due to the high speed rotation of the polygon mirror of the optical deflector 20 is almost completely shut off.

The wall body of a main unit sound insulating case 35 is arranged in spaced relation to the outer periphery of the sound-insulating case 34 for the fθ lens. A cover glass 14 of the polygon mirror 21 is mounted on the opening 35A of the main unit sound insulating case 35 so that the opening 35A is sealed. The main unit sound insulating case 35 accommodates the polygon mirror 21, the fθ lens 12, the second cylindrical lens 13 and others. The opening thereof is sealed with a cover glass 14 as an example of the transparent vibration proof member.

This configuration allows the optical deflector 20 and the incident optical system to be sealed and accommodated in the acoustic sealing case 34. They are further sealed and accommodated in the main unit sound insulating case 35. This double sound insulation structure almost completely shuts out the ambient noise due to the high speed rotation of the polygon mirror of the optical deflector 20 and noise due to vibration of the acoustic sealing case 34.

Since a material having high density or a member having much thickness shows more attenuation efficiency to vibration, the use of glass rather than plastic for the fθ lens 12 and the cylindrical lens 13 is more preferable. Similarly, the use of glass to the cover glass 14 is also preferable from the viewpoint of sound insulation.

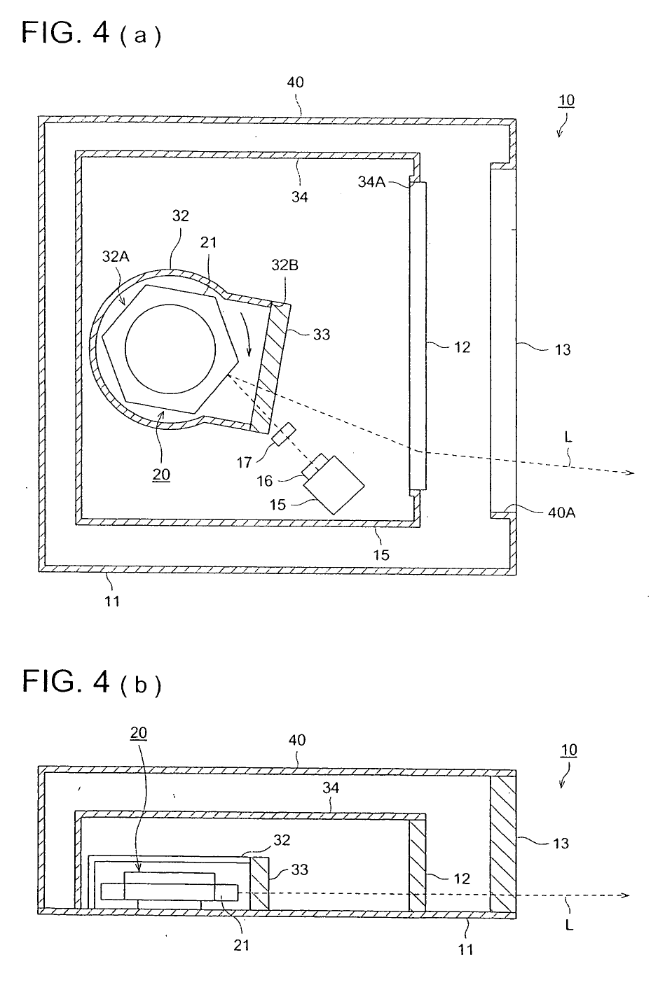

FIGS. 4(a) and 4(b) shows an embodiment of the second embodiment of a sound-insulating means of the optical scanning apparatus 10. FIG. 4(a) is a plan cross sectional view of the same, and FIG. 4(b) a front cross sectional view.

A rotary space 32A for accommodating rotatably the polygon mirror 21 is formed inside the protective case 32 for accommodating the optical deflector 20. The rotary space 32A is formed in a cylindrical form having a center approximately coincident with the rotating center of the polygon mirror 21.

The protective case 32 is equipped with an opening 32B for allowing laser beam to pass through. The opening 32B is provided with a soundproofing glass 33.

The optical deflector 20 is sealed and accommodated in the protective case 32. Thus, ambient noise due to the high speed rotation of the polygon mirror of the optical deflector 20 is almost completely shut off.

The protective case 32 accommodating the optical deflector 20 and the incident optical system constituted by a semiconductor laser 15, a collimator lens 16 and a first cylindrical lens 17 are arranged inside the sound-insulating case 34 for the fθ lens. The fθ lens for ensuring uniform speed of optical scanning on the photoconductor is mounted on the opening 34A of the sound-insulating case 34 for the fθ lens, whereby the opening 34A is sealed. This configuration allows the optical deflector 20 and the incident optical system to be sealed and accommodated in the sound-insulating case 34 for the fθ lens, with the result that ambient noise due to the high speed rotation of the polygon mirror of the optical deflector 20 is more effectively shut off.

The wall body of a sound insulating case 40 for the cylindrical lens is arranged in spaced relation with the outer periphery of the sound-insulating case 34 for the fθ lens. A cylindrical lens 13 for correcting the surface tilt of the polygon mirror 21 is mounted on the opening 40A of the sound insulating case 40 for the cylindrical lens, and the opening 40A is sealed.

This configuration allows the optical deflector 20 to be sealed and accommodated in protective case 32. The protective case 32 and the incident optical system are further sealed and accommodated in the sound-insulating case 34 for the fθ lens. Further, they are sealed and accommodated in the sound insulating case 40 for the cylindrical lens. This triple sound insulation structure completely shuts out the ambient noise due to the high speed rotation of the polygon mirror of the optical deflector 20 and noise due to vibration of sound insulating case for the fθ lens.

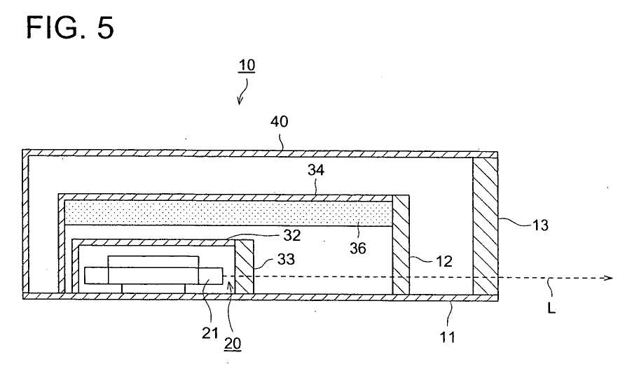

FIG. 5 is a front cross sectional view of the third embodiment of a sound-insulating means of the optical scanning apparatus 10. Regarding the reference numeral used with reference to FIG. 5, the components having the same functions as those in FIGS. 4(a) and 4(b) will be assigned with the same reference numbers and will not be described in order to avoid duplication. The following describes the points different from those of the second embodiment.

Being protected by the protective case 32, sound-insulating case 34 for the fθ lens and the sound insulating case 40 for the cylindrical lens, the optical scanning apparatus 10 is designed in a triple sound insulation structure. A sound insulation member 36 is mounted on the ceiling inside the sound-insulating case 34 for the fθ lens. The sound insulation member 36 is made of a foamed elastic member to absorb the noise leading from the protective case 32 and the vibration of the sound-insulating case 34 for the fθ lens.

When there is an increase in the speed of the rotary unit including the polygon mirror 21, the ambient noise resulting from the polygon mirror 21 becomes proportional to the 6th power of the speed, with the result that there is a tremendous increase in the frequency component noise of speed by the number of the polygon mirror and motor exciting frequency noise. The insulating case built in a double or triple structure protects the optical scanning apparatus 10 perfectly against noise and prevents the noise from going outside, whereby quiet-down performance is achieved.

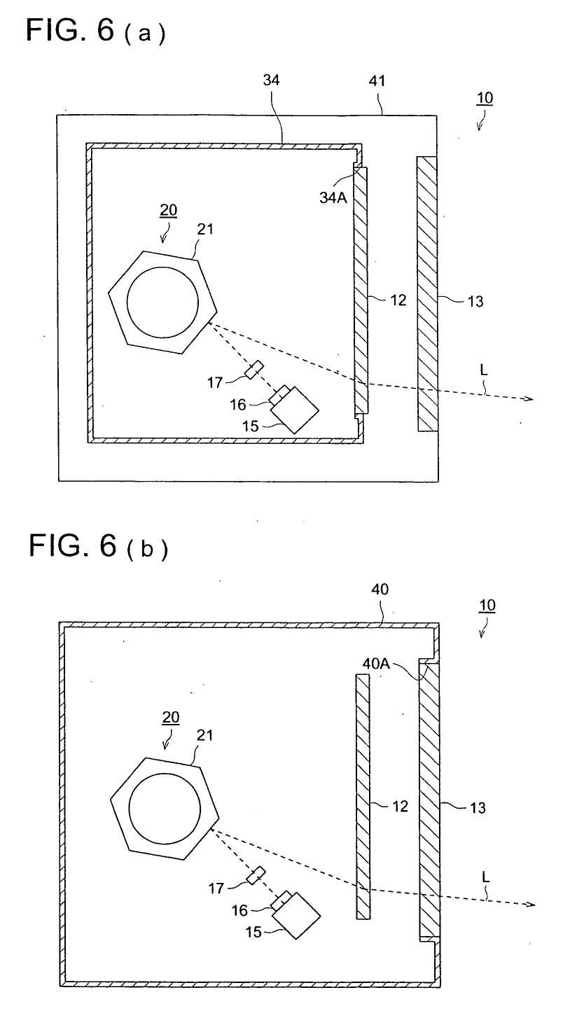

FIG. 6(a) is a plan cross sectional view showing another embodiment of the optical scanning apparatus 10.

The optical deflector 20 and the incident optical system are housed in the sound-insulating case 34 for the fθ lens equipped with an opening 34A that allows passage of the light beam L that passes through the fθ lens 12. The opening 34A of the sound-insulating case 34 for the fθ lens is sealed by the fθ lens 12. This completely shuts out the noise of wind sound that is produced by the high speed rotation of the polygon mirror 21 of the optical deflector 20. Numeral 41 denotes a case containing the cylindrical lens.

FIG. 6(b) is a plan cross sectional view showing still another embodiment of the optical scanning apparatus 10.

The optical deflector 20, the incident optical system and the fθ less 12 are accommodated in the sound insulating case 40 equipped with the opening 40A allowing the passage of the light beam L passing through the cylindrical lens 13. The opening 40A of the sound insulating case 40 for cylindrical lens is sealed by the cylindrical lens 13. This structure completely shuts out the ambient noise due to the high speed rotation of the polygon mirror 21 of the optical deflector 20.

It is preferred that the optical deflector 20 shown in FIGS. 6(a) and 6(b) be accommodated in the protective case 32 and soundproofing glass 33 shown in FIGS. 4(a) and 4(b), and be further accommodated in the sound-insulating case 34 for the fθ lens or main unit sound insulating case 35 whereby a double sound insulation structure is preferably formed.

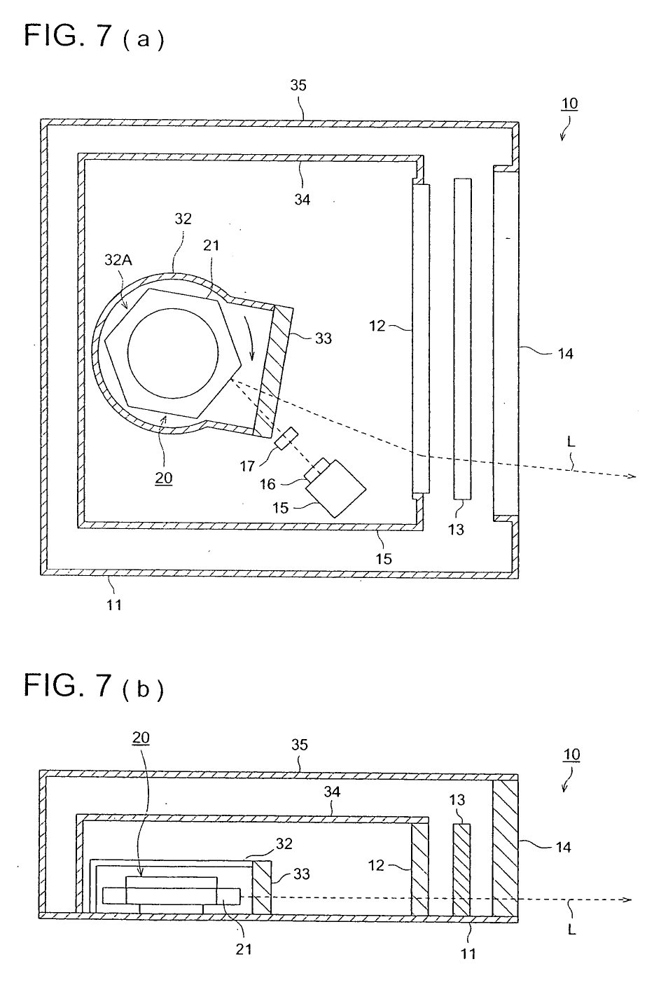

FIGS. 7(a) and 7(b) show a further another embodiment of the optical scanning apparatus 10. This embodiment is built in a triple sound insulation structure, constituted by the protective case 32, sound-insulating case 34 for the fθ lens and main unit sound insulating case 35. An effective use of the fθ lens 12 ensures a compact overall configuration and excellent sound insulation characteristics of the scanning apparatus.

As described above, the optical scanning apparatus of the present invention completely shuts out the ambient noise due to the high speed rotation of the polygon mirror and the vibration of the case, whereby quiet-down performance is achieved.

1. An optical scanning apparatus comprising:
(a) an optical deflector having a rotatable polygon mirror for reflecting a light beam projected thereon;
(b) an fθ lens for transmitting the light beam reflected on a light reflecting surface of the polygon mirror;
(c) a cylindrical lens for transmitting the light beam passing through the fθ lens; and
d) a sound-insulating case (34) for the fθ lens having an opening through which the light beam passing through the fθ lens passes,
wherein the sound-insulating case houses the optical deflector and the opening of the sound-insulating case is sealed hermetically with the fθ lens.

2. The optical scanning apparatus of claim 1, further comprising a sound-insulating case (40) for the cylindrical lens having an opening through which the light beam transmitting through the cylindrical lens passes and the opening is sealed hermetically with the cylindrical lens.

3. The optical scanning apparatus of claim 1, wherein the reflector is housed in a protection case (32) in which the opening is sealed hermetically with a transparent soundproofing member.

4. The optical scanning apparatus of claim 3, wherein a sound insulating member is mounted on a ceiling inside the sound-insulating case (34) for the fθ lens.

5. The optical scanning apparatus of claim 4, wherein the sound insulating member is made of a foamed elastic member.

6. The optical scanning apparatus of claim 1, further comprising a main unit sound-insulating case (35) having an opening though which the light beam transmitting and the opening is sealed with the transparent vibration proof member.

7. The optical scanning apparatus of claim 6, wherein the deflector is housed in a protection case (32) in which the opening is sealed hermetically with a transparent soundproofing glass.

8. The optical scanning apparatus of claim 1, wherein the deflector is housed in a protection case (32) in which the opening is sealed hermetically with a transparent soundproofing glass.
